(19) United States
(12) Patent Application Publication
(10) Pub. No.: US 2003/0126286 A1
(43) Pub. Date: Jul. 3, 2003

(54) Method for interfacing between different QoS offering methods

(75) Inventor: Ki Young Lee, Anyang-si (KR)

Correspondence Address: FLESHNER & KIM, LLP, P.O. BOX 221200, CHANTILLY, VA, 20153, US

(73) Assignee: LG Electronics Inc.

(21) Appl. No.: 10/301,626

(22) Filed: Nov. 22, 2002

(30) Foreign Application Priority Data
Dec. 28, 2001 (KR) 87470/2001

(51) Int. Cl. G06F 15/173

(52) U.S. Cl. 709/238

(57) ABSTRACT

Disclosed herein is a method for interfacing between different QoS offering methods. An equipment that supports only a first QoS method without supporting a second QoS method can be operated to support the second method. Additionally, an equipment that supports only the second QoS method without supporting the first QoS method can be operated to support the first method. Therefore, data can be transmitted more efficiently by granting a high level of priority to packets that cannot have a high level of priority in existing boundary routers.

### BACKGROUND OF THE INVENTION

1. Field of the Invention

The present invention relates to a method for interfacing different QoS offering methods, and more particularly to a method for interfacing equipment that supports only a first QoS method without supporting a second QoS method to support the second QoS method.

2. Background of the Related Art

As the Internet is being developed, users desire a high level of quality of Internet service. Particularly, as multimedia services become popular, a real time process for such services is required and the number and kinds of services requiring a wide bandwidth are increasing.

Currently, to properly support these multimedia services that are desired by a number of users, transmission networks are being expanded and studies on an efficient use of the existing networks are progressing.

Quality of Service (QoS) is one technique for supporting these multimedia services. QoS is a technique required for continuously guaranteeing a level of service with which a user can be satisfied after a specific bandwidth is assigned to the user.

Several particular application programs require a high level of QoS. However, these programs cannot guarantee a high quality of service since IP-based Internet networks only provide a best effort data transmission service. Accordingly, guarantee of QoS is an indispensable requirement for Voice Over Internet Protocol (VoIP) realization.

The QoS guarantee is generally divided into two methods. The first is a resource reservation method and the second is a priority method.

The resource reservation method uses the resource of the network already assigned according to a QoS request. The priority method grants a priority based on a kind of packet, such that a packet having a higher priority has a better quality of service.

Generally, the priority method uses either IEEE802.1p or a ToS (Type of Service) byte.

In the IEEE802.1p method, a Tag Control Information (TCI) field of 4 bytes is added to a MAC header of Layer 2, and 3 bits of the field are used as a 802.1p identifier.

The priority level expressible by the 3 bits is 8. A network equipment supporting the IEEE802.1p classifies and services packets based on the priority.

FIG. 1 is a diagram showing a TCI field format of the IEEE802.1p packet. As shown in FIG. 1, a layer 2 header of the IEEE802.1p packet includes a 4 byte TCI field in addition to a Destination field, a Source field, and a Type/Length field.

The TCI field includes a 2 byte field in which 8100h is always set for an Ethernet frame, a 3 bit 802.1p identifier field, a 3 bit unused field, and a 12 bit 802.1Q VLAN identifier field. The 802.1p identifier field is used to determined the 8 priority level.

A matching between binary codes of the 802.1p identifier and the priority levels is described in Table 1 below.

TABLE 1

| priority | binary | characteristic |
|---|---|---|
| 0 | 000 | Background |
| 1 | 001 | Spare |
| 2 | 010 | Best Effort |
| 3 | 011 | Excellent Effort |
| 4 | 100 | Controlled Load |
| 5 | 101 | Video |
| 6 | 110 | Voice |
| 7 | 111 | Network Control |

Since a 4 byte frame is added to the IEEE802.1p header, a length of the MAC header is changed. Accordingly, a network equipment that does not support the IEEE802.1p may recognize a received IEEE802.1p packet as an erroneous packet and discard the packet. Accordingly, an upgrade of the network equipment is needed to process the IEEE802.1p packet.

On the other hand, the method of using the ToS byte is classified into two methods. The first is an IP precedence bits method and the second is a DiffServ (Differentiated Service) method.

The IP precedence bits method uses 3 bits of the ToS byte of an IP header as IP precedence bits in order to provide the 8 priority levels.

FIG. 2 is a diagram showing an IP precedence bits format. The IP precedence bits method uses the ToS byte of the IP header as shown in FIG. 2. Referring to FIGS. 2, 3 bits (0 2) are used as precedence bits and a priority is granted as described in Table 2 below.

TABLE 2

| priority | binary | characteristic |
|---|---|---|
| 0 | 000 | Routine |
| 1 | 001 | Priority |
| 2 | 010 | Immediate |
| 3 | 011 | Flash |
| 4 | 100 | Flash Override |
| 5 | 101 | CRITIC/ECP |
| 6 | 110 | Internet Control |
| 7 | 111 | Network Control |

Finally, the DiffServ method is a priority grant method having a concept of QoS where levels of services are changed depending on a request level of user.

FIG. 3 is a diagram showing the DiffServ Code Point (DSCP) format. In the DiffServ method, a DSCP format is included as shown in FIG. 3 using the ToS byte. Referring to FIG. 3, a DSCP consisting of six bits, that is, 0 5 bits, is used to make a maximum of 64 classes in order to provide different quality of service

A forwarding scheme based on the DSCP code is referred to as Per Hop Behavior (PHB). PHB is a standard form recommended by Internet Engineering Task Force (IETF) (see REC 2597), and is classified into Default PHB, Assured Forwarding (AF), and Expedited Forwarding (EF), depending on a kind of quality of service. In addition, a class selector class for an interface with the IP precedence bits method is further included.

The following Table 3 shows the PHB and a code standard form thereof except for an AF class.

TABLE 3

| PHB | Code Point |
|---|---|
| Default | 000000 |
| Class Selector | xxx000 |
| Expedited Forwarding | 101110 |

In addition, the following Table 4 shows a code standard form of the AF class excluded from Table 3.

TABLE 4

| Class Drop | | | | |
|---|---|---|---|---|
| Precedence | Class1 | Class2 | Class3 | Class4 |
| Low | 001 010 | 010 010 | 011 010 | 100 010 |
| Medium | 001 100 | 010 100 | 011 100 | 100 100 |
| High | 001 110 | 010 110 | 011 110 | 100 110 |

The DiffServ method is a QoS offering method focusing on expansion. Under this method, a proper performance maintenance and a realization facility can transmit at once a large quantity of packets directed to the same destination using a collective bandwidth, without individually considering different requests from users.

In other words, when a bandwidth is collectively reserved beforehand and packets are to be transmitted to same destination, the packets carried on the reserved bandwidth are transmitted. The use of the collective bandwidth allows the reduction of overhead at intermediate nodes since requests for resource reservation of incoming packets need not to be individually processed.

As described above, there are several methods of granting a priority to packets. Of such several methods, the IP precedence bits method is included as one class in the DiffServ method such that both methods can be interfaced each other.

However, these methods have various problems. For example, since the IEEE802.1p method and the DiffServ method have different service application layers, these methods cannot be used integrally, unlike a case of the IP precedence bits method. Therefore, network equipment supporting only the DiffServ method cannot offer requested services to packets having only IEEE802.1p information. Similarly, network equipment supporting only the IEEE802.1P method cannot offer requested services to packets having only DiffServ information. Accordingly, an efficient packet process between the IEEE802.1P method and the DiffServ method cannot be achieved.

In addition, since the IEEE802.1p packet has tag information within the layer2 header, the tag information can be read only at a switch level. Accordingly, services by the IEEE802.1p method cannot be offered to a boundary router and the like requiring services based on a priority due to frequent bottle necking.

Accordingly, there is a need to provide an interface function between the IEEE802.1P method and the DiffServ method for an efficient packet processing.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

Another object of the present invention is to provide a method for interfacing between different QoS offering methods, which allows an equipment that supports only a first method without supporting a second method to support the second method.

Another object of the present invention is to provide a method for interfacing between different QoS offering methods, which allows an equipment that supports only a second method without supporting a first method to support the first method.

In order to achieve at least the above objects, in whole or in parts, there is provided a method for interfacing between different QoS offering methods including the steps of searching a MAC frame of packets received at ports of an equipment that supports only a first method without supporting a second method in order to determine whether the received packets are packets of the second method, and if it is determined that the received packets are packets of the second method, loading a TCI field of a layer 2 header of the received packets into the equipment; classifying values of the loaded TCI field into 8 levels of priority using a tag of the second method; transforming the loaded TCI field into a corresponding PHB based on a preset transformation table, depending on the levels of priority; and indicating the PHB by a corresponding DSCP code and transmitting the indicated DSCP code by means of a switch.

Additionally, in order to achieve at least the above objects, in whole or in parts, there is provided a method for interfacing between different QoS offering methods including determining whether packets received through a switch in an equipment that supports only a second method without supporting a first method are packets of the first method; if it is determined that the received packets are packets of the first method, loading a DSCP included in a ToS of an IP header of the received packet into the equipment; deciding a PHB corresponding to codes of the loaded DSCP and transforming the PHB into corresponding levels of priority of the second method based on a preset transformation table; and indicating the levels of priority by a corresponding TCI field and transmitting the indicated TCI field by means of ports.

By these methods, the network equipment that does not support a level of priority of the second priority can perform the second method by using tag information of the second method.

Accordingly, the preferred embodiment allows the priority of the first method to be applied to a boundary router in which a bottle neck phenomenon occurs by using the priority of the second method.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a diagram showing a TCI field format of IEEE802.1p;

FIG. 2 is a diagram showing a format of IP precedence bits;

FIG. 3 is a diagram showing a DSCP format;

FIG. 4 is a flowchart illustrating an operation sequence for transforming IEEE802.1p packets into DiffServ packets in a method of interfacing between IEEE802.1p and DiffServ according to a preferred embodiment of the present invention; and

FIG. 5 is a flowchart illustrating an operation sequence for transforming DiffServ packets into IEEE802.1p packets in a method of interfacing between IEEE802.1p and DiffServ according to the preferred embodiment of the present invention.

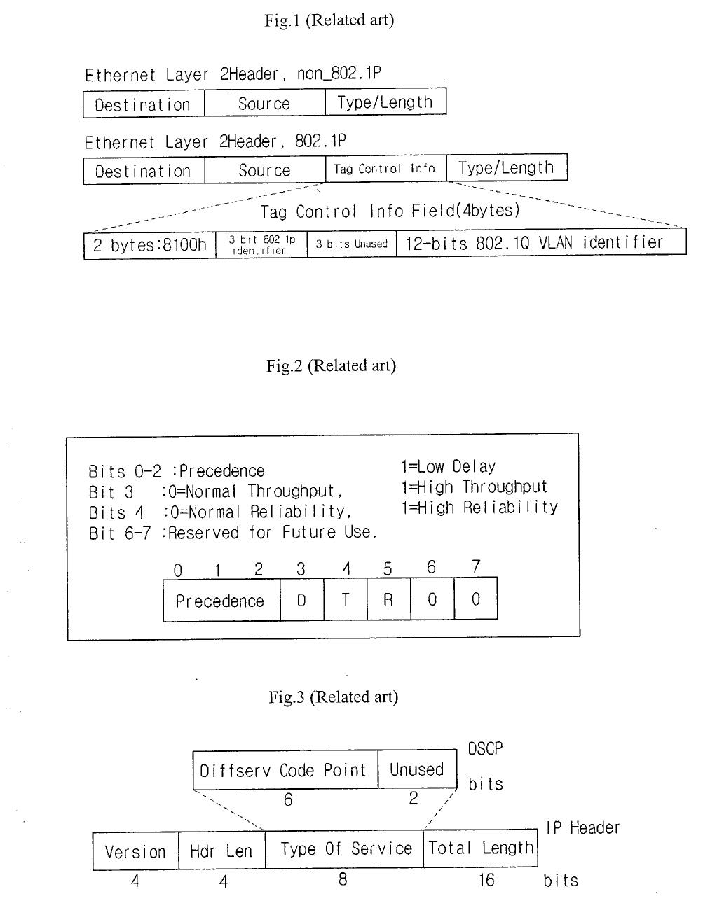

### DETAILED DESCRIPTION OF PREFERRED EMBODIMENTS

Hereinafter, a method for interfacing between different QoS offering methods according to the preferred embodiment of the present invention will be described in conjunction with the accompanying drawings.

For purposes of description, of the different QoS offering methods, DiffServ is herein defined as a first method and IEEE802.1p is herein defined as a second method. It should be understood that either could be the first.

In the preferred embodiments of the present invention, processes for transforming a priority level of IEEE802.1p into PHB of DiffServ and vice versa ate preferably added to an existing process.

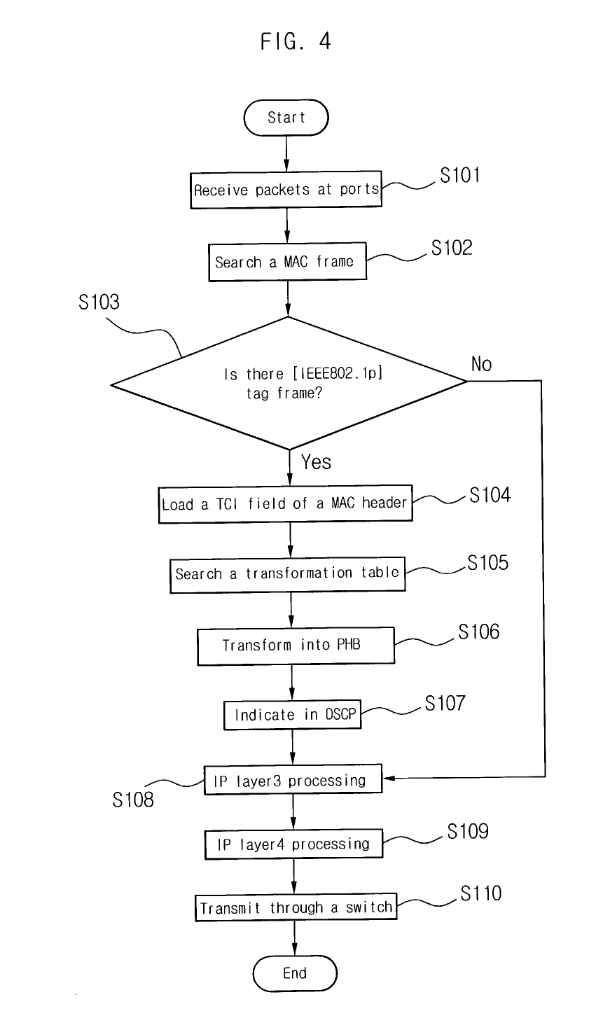

FIG. 4 is a flowchart illustrating an operation sequence for transforming IEEE802.1p packets into DiffServ packets to allow interfacing between IEEE802.1p and DiffServ, according to a preferred embodiment of the present invention.

Referring to FIG. 4, when an IEEE802.1p packet is to be transformed into a DiffServ packet, the IEEE802.1p packet is first received through a port (S101). Next, a frame of MAC is searched (S102) and it is determined whether an IEEE802.1p tag is present or not (S103).

At that time, if a length of a header of the MAC frame is longer than the length of an original basic header by 4 bytes, it is determined that the IEEE802.1p tag is present.

When it is determined that the IEEE802.1p tag is present, TCE field of a MAC header is loaded into the equipment (S104). Next, a prescribed priority transformation table for transforming the IEEE802.1p packet into a DiffServ packet is searched (S105). Then, the IEEE802.1p packet is transformed into a corresponding PHB (S106), and a DSCP of the IP header is changed to a code corresponding to the PHB (S107).

As used herein, the priority transformation table is a table for matching the TCE field of IEEE802.1p corresponding with the PHB and DSCP of DiffServ, and is defined in Table 5 below.

TABLE 5

| | |
|---|---|
| IEEE802.1p | DiffServ |

| Binary | characteristic | PHB | DSCP |
|---|---|---|---|
| 000 | Background | Default | 000 000 |
| 001 | Spare | | |
| | | Class Selector | xxx 000 |
| 010 | Best Effort | Assured Forwarding | 001 110 |
| | | (Class 1) | 001 100 |
| | | | 001 010 |
| 011 | Excellent Effort | Assured Forwarding | 010 110 |
| | | (Class 2) | 010 100 |
| | | | 010 010 |
| 100 | Controlled Load | Assured Forwarding | 011 110 |
| | | (Class 3) | 011 100 |
| | | | 011 010 |
| 101 | Video | Assured Forwarding | 100 110 |
| | | (Class 4) | 100 100 |
| | | | 100 010 |
| 110 | Voice | Expedited | 101 110 |
| 111 | Network Control | Forwarding | |

When the IEEE802.1p packet format is transformed into the DiffServ packet format according to Table 5, the DiffServ packet is processed in an IP layer 3 (S108) and an IP layer4(S109). Then, the DiffServ packet is transmitted to a destination through a switch (S110).

If it is determined that the packet does not include an IEEE802.1p tag frame in step S103, the packet received through the port is determined to be a DiffServ packet and is directly processed in the IP layer3 (S108) and the IP layer4 (S109). The packet is then transmitted to a destination through the switch (S110).

As described above, in the method of transforming the IEEE802.1p packet into the DiffServ packet, if the length of the MAC frame header received in the equipment is longer by 4 bytes than the length of an original MAC frame header, the TCI field of the MAC header is loaded, a corresponding PHB is searched from the transformation table as shown in Table 5, and then indicated by DSCP which is to be transmitted through the switch.

Next, a method of transforming a DiffServ packet into the IEEE802.1p packet will be described.

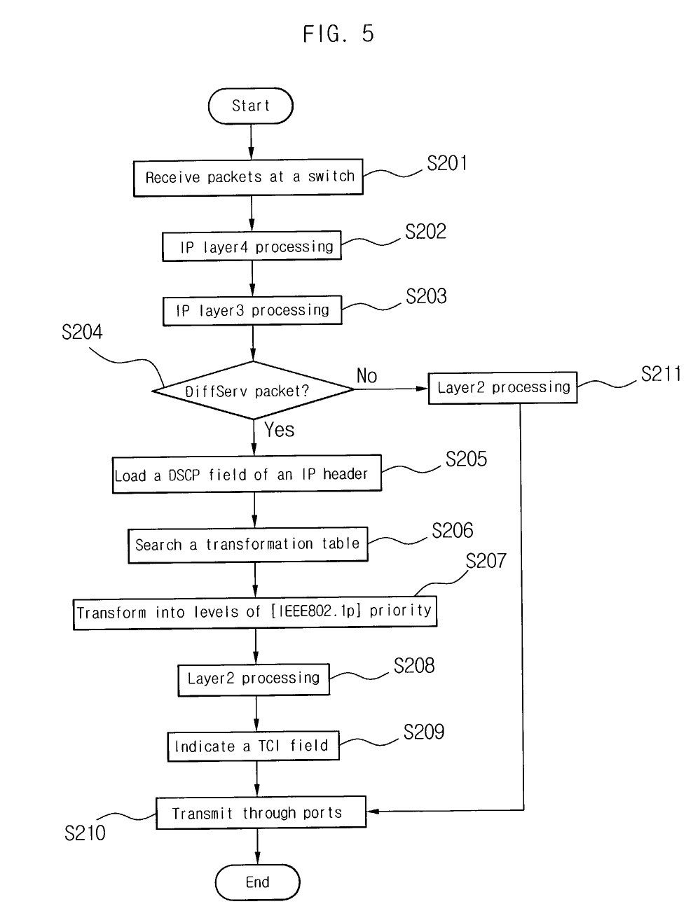

FIG. 5 is a flowchart illustrating an operation sequence for transforming DiffServ packets into IEEE802.1p packets, according to the preferred embodiment of the present invention.

Referring to FIG. 5, when the DiffServ packet is to be transformed into the IEEE802.1p packet, a packet received (S201) through the switch is processed first in the IP layer4 (S202) and then in the IP layer3 (S203) under an operation control of the equipment.

Next, it is determined whether the received packet is a DiffServ packet (S204). If it is confirmed that the received packet is a DiffServ packet, the DSCP field of the IP header is loaded (S205). Subsequently, after searching the prescribed transformation table (for example, the table shown in Table 5) (S206), a transformation into an IEEE802.1p priority corresponding to the PHB corresponding to the DSCP is performed (S207).

Here, if values other than ‘0’ are set in the ToS byte of the received packet, it can be determined that the received packet is the DiffServ packet.

After performing the priority transformation, the priority is processed in layer2 (S208) and then indicated by a code corresponding to the TCI field of the MAC header (S209). The transformed packet is then transmitted through the port (S210).

As described above, in the method of transforming the DiffServ packet into the IEEE802.1p packet, the DSCP field of the IP header is read and the corresponding IEEE802.1p priority is searched from the transformation table as shown in Table 5 and then indicated in the TCI field.

As described above, the preferred embodiment of the present invention has many advantages. For example, the network equipment that does not support the level of IEEE802.1p priority can offer the DiffServ packet by using the IEEE802.1p tag information. Thus, the network equipment does not support a level of priority of the second priority can perform the second method by using tag information of the second method.

Accordingly, the present invention has an advantage that the IEEE802.1p priority is applicable to the DiffServ priority in the boundary router where the bottle neck phenomenon occurs. Accordingly, the preferred embodiment allows the priority of the first method to be applied to a boundary router in which a bottle neck phenomenon occurs by using the priority of the second method.

Therefore, the preferred embodiment can efficiently transmit data by granting a high level of priority to packets that cannot have a high level of priority in existing boundary routers.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method for interfacing equipment supporting different QoS offering methods, comprising:
searching a MAC frame of a received packet, the packet being received at a port of an equipment that supports only a first QoS method without supporting a second QoS method, to determine whether the received packet is of the first or second QoS method;
if it is determined that the received packet is a packet of the second QoS method, loading a Tag Control Information (TCI) field of a layer 2 header of the received packet into the equipment;
classifying values of the loaded TCI field into a plurality of priority levels using a tag of the second QoS method;
transforming the loaded TCI field into a corresponding Per Hop Behavior (PHB) based on a transformation table, depending on the level of priority; and
indicating the PHB by a corresponding DiffServ Code Point (DSCP) code.

2. The method of claim 1, further comprising transmitted the packet with the indicated DSCP code by means of a switch.

3. The method of claim 1, wherein the received packet is determined to be a packet of the second QoS method if a length of the MAC frame is different from a length of an ordinary MAC frame of the first method.

4. The method of claim 3, wherein a size of the MAC header of the first QoS method is 4 bytes greater than a size of the MAC header of the second QoS method.

5. The method of claim 1, wherein the transformation table classifies the TCI field of the second QoS method into prescribed levels of priority, defines a PHB field of the first method corresponding to the prescribed levels of priority, and defines values of DSCP codes corresponding to the PHB field.

6. The method of claim 1, wherein indicating the PHB by a corresponding DSCP code further comprises:
processing the packet indicated by the DSCP code in an IP layer 3; and
processing the packets processed in the IP layer 3 in an IP layer 4.

7. The method of claim 1, wherein if it is determined that the received packet is not a packet of the second QoS method, the rece3ived packet is processed in an IP layer3 and an IP layer4 according to a procedure for packet processing of the first method.

8. The method of claim 1, wherein a first method is a DiffServ method.

9. The method of claim 1, wherein a second method is an IEEE802.1p method.

10. A method for interfacing equipment supporting different QoS methods, comprising:
determining whether a packet received through a switch in an equipment that supports only a second QoS method without supporting a first QoS method is a packet of the first method;
if it is determined that the received packet is a packet of the first QoS method, loading a DSCP included in a ToS of an IP header of the received packet into the equipment;
determining a PHB corresponding to codes of the loaded DSCP and transforming the PHB into corresponding levels of priority of the second method based on a transformation table; and
indicating the priority level as a corresponding TCI field.

11. The method of claim 10, further comprising transmitting the packet with the indicated TCI field by means of a port.

12. The method of claim 10, wherein determining whether the packet received through a switch is the packet of the first method comprises,
processing the received packet in an IP layer4 and an IP layer 3, and
determining that the received packet is of the first QoS method if a length of the processed packet is different from a length of a packet of the second QoS method.

13. The method of claim 10, wherein the transformation table defines PHB matching codes of DSCP of the first QoS method, defines levels of priority corresponding to the PHB, and defines the levels of priority as codes of the TCI field.

14. The method of claim 10, wherein indicating the levels of priority by a corresponding TCI field comprises processing packets transformed into levels of priority of the second QoS method in a layer2 such that the TCI field is indicated in a MAC header of the layer2 of the packet.

15. The method of claim 10, wherein a first QoS method is a DiffServ method.

16. The method of claim 10, wherein a second QoS method is an IEEE802.1p method.

17. A method of converting a data packet from a first quality of service (QoS) structure to a second QoS structure to determine a priority level of the data packet at a system configured to receive data packets of the second QoS structure, comprising:
receiving a data packet having a first quality of service (QoS) structure at a system configured for a second QoS structure;
analyzing a TCI field of a layer two header of the received data packet to determine a priority level of the data packet;
transforming the priority level of the TCI field into a corresponding PHB using a transformation table; and
indicating the PHB by a corresponding DSCP code of the data packet.

18. The method of claim 17, wherein the first QoS structure is IEEE802.1p and wherein the second QoS structure is DiffServ.

19. The method of claim 17, wherein the transformation table is used to translate priority information from the first QoS structure to prior to information of the second QoS structure.

20. The method of claim 19, wherein the transformation table classifies the TCI field of the first QoS structure into a prescribed priority level, defined as the PHB field of the second QoS structure corresponding to the prescribed levels of priority, and defined values of DSCP codes corresponding to the PHB field.

21. The method of claim 19, wherein the transformation table defines PHB matching codes of DSCP of the first QoS method, defines levels of priority corresponding to the PHB, and defines the levels of priority as codes of the TCI field.

22. A method of converting a data packet from a first quality of service (QoS) structure to a second QoS structure to determine a priority level of the data packet received at a system configured to receive data packets of the second QoS structure, comprising:
receiving a data packet having a first quality of service (QoS) structure at a system configured for a second QoS structure;
analyzing prescribed header information of the received data packet to determine a priority level of the data packet;
transforming the priority level information from the header of the received data packet into a corresponding priority level of the second QoS structure using a transformation table; and
modifying the header information of the received data packet to include the transformed priority level corresponding to the second QoS structure.

23. The method of claim 22, wherein the first QoS structure is DiffServ, and wherein the second QoS structure is IEEE802.1p.

24. The method of claim 22, wherein the first QoS structure is IEEE802.1p, and wherein the second QoS structure is DiffServ.

25. The method of claim 22, wherein the transformation table comprises priority classifications for TCI fields and PHB fields, and defines values of DSCP codes corresponding to the PHB fields, and wherein a correspondence between priorities of the TCI fields and the PCB fields are provided.
